(19) United States
(12) Patent Application Publication
(10) Pub. No.: US 2025/0336177 A1
(43) Pub. Date: Oct. 30, 2025

(54) POSE ANALYZING APPARATUS, POSE ANALYZING METHOD, AND NON-TRANSITORY COMPUTER-READABLE STORAGE MEDIUM

(71) Applicant: NEC Corporation, Minato-ku, Tokyo (JP)

(72) Inventors: Karen STEPHEN, Tokyo (JP); Jianquan LIU, Tokyo (JP); Noboru YOSHIDA, Tokyo (JP); Ryo KAWAI, Tokyo (JP); Satoshi YAMAZAKI, Tokyo (JP); Tingting DONG, Tokyo (JP); Naoki SHINDOU, Tokyo (JP); Yuta NAMIKI, Tokyo (JP); Youhei SASAKI, Tokyo (JP)

(73) Assignee: NEC Corporation, Minato-ku, Tokyo (JP)

(21) Appl. No.: 18/864,960

(22) PCT Filed: Jun. 3, 2022
(86) PCT No.: PCT/JP2022/022606

§ 371 Date: Nov. 12, 2024

(51) Int. Cl. G06V 10/74; G06T 5/50; G06T 7/73; G06V 10/762; G06V 40/10; G06V 40/20

(52) U.S. Cl. CPC G06V 10/761; G06T 5/50; G06T 7/74; G06V 10/762; G06V 40/103; G06V 40/23

(57) ABSTRACT

A pose analyzing apparatus acquires a target image and target person information. The target image includes two or more persons who do arbitrary thing, such as giving a performance, doing exercises, playing music instruments, etc. The pose analyzing apparatus estimates a pose for each person and computes, for each person, a pose score that represents quality of pose of the person. The pose analyzing apparatus detects one or more reference persons whose pose score is greater than the pose score of the target person, and outputs reference information that indicates the reference person.

### TECHNICAL FIELD

The present disclosure generally relates to a pose analyzing apparatus, a pose analyzing method, and a non-transitory computer-readable storage medium.

### BACKGROUND ART

There are techniques to analyze an image of a person. PTL1 discloses a system that analyzes an image of a class student to determine a current class status, such as a degree of concentration. The class status is determined by comparing the characteristics, e.g., pose, of the class student captured on the image with those obtained from a pre-stored class status sample image.

### CITATION LIST

### Patent Literature

PTL1: US Patent Publication No. US2020/0126444

### SUMMARY OF INVENTION

### Technical Problem

PTL1 does not disclose a technique to handle an image on which two or more persons are captured. An objective of the present disclosure is to provide a novel technique to analyze poses of persons using an image on which two or more persons are captured.

### Solution to Problem

The present disclosure provides a pose analyzing apparatus comprising at least one memory that is configured to store instructions and at least one processor.

The at least one processor is configured to execute the instructions to: acquire a target image on which two or more persons are captured; acquire target person information that indicates a target person; estimate a pose for each one of the persons captured on the target image; compute, for each one of the persons, a pose score that represents quality of pose of the person; detect one or more reference persons whose quality of pose is higher than quality of pose of the target person; and output reference information that indicates the reference person.

The present disclosure further provides a pose analyzing method performed by a computer.

The pose analyzing method comprises: acquiring a target image on which two or more persons are captured; acquiring target person information that indicates a target person; estimating a pose for each one of the persons captured on the target image; computing, for each one of the persons, a pose score that represents quality of pose of the person; detecting one or more reference persons whose quality of pose is higher than quality of pose of the target person; and outputting reference information that indicates the reference person.

The present disclosure further provides a non-transitory computer readable storage medium storing a program.

The program causes a compute to execute: acquiring a target image on which two or more persons are captured; acquiring target person information that indicates a target person; estimating a pose for each one of the persons captured on the target image; computing, for each one of the persons, a pose score that represents quality of pose of the person; detecting one or more reference persons whose quality of pose is higher than quality of pose of the target person; and outputting reference information that indicates the reference person.

### Advantageous Effects of Invention

According to the present disclosure, a novel technique to analyze poses of persons using an image on which two or more persons are captured is provided.

### BRIEF DESCRIPTION OF DRAWINGS

FIG. 1 illustrates an overview of a pose analyzing apparatus.

FIG. 2 is a block diagram illustrating an example of a functional configuration of the pose analyzing apparatus.

FIG. 3 is a block diagram illustrating an example of a hardware configuration of the pose analyzing apparatus.

FIG. 4 is a flowchart illustrating an example flow of processes performed by the pose analyzing apparatus.

FIG. 5 illustrates the classification of persons in which the type of pose is taken into consideration.

FIG. 6 illustrates an example of the output image.

FIG. 7 illustrates an overview of a pose analyzing apparatus of the second example embodiment.

FIG. 8 is a block diagram illustrating an example of the functional configuration of the pose analyzing apparatus of the second example embodiment.

FIG. 9 is a flowchart illustrating an example flow of processes performed by the pose analyzing apparatus of the second example embodiment.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predetermined information (e.g., a predetermined value or a predetermined threshold) is stored in advance in a storage device to which a computer using that information has access unless otherwise described.

### EXAMPLE EMBODIMENT 1

### Overview

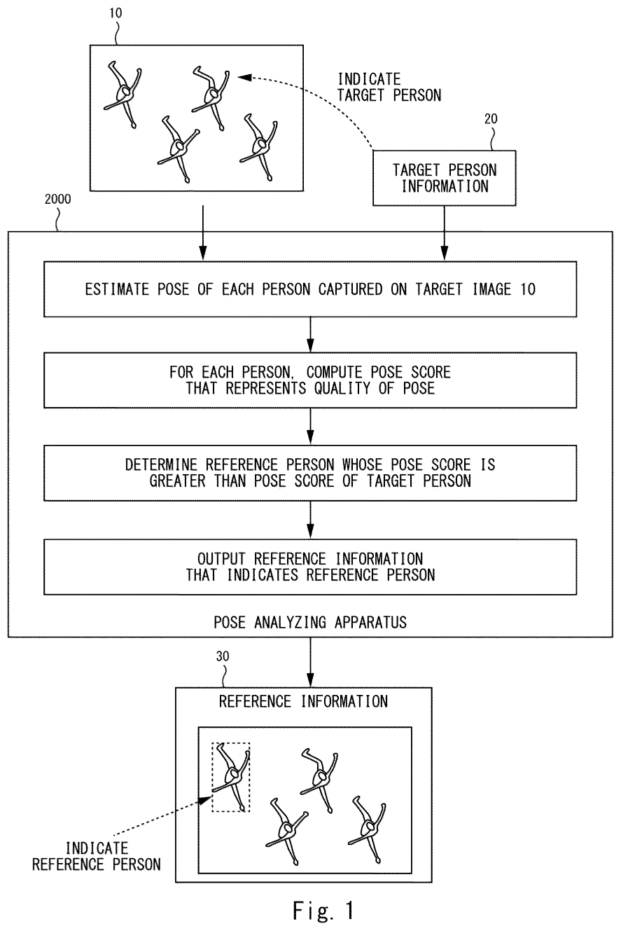

FIG. 1 illustrates an overview of a pose analyzing apparatus 2000 of the first example embodiment. It is noted that the overview illustrated by FIG. 1 shows an example of operations of the pose analyzing apparatus 2000 to make it easy to understand the pose analyzing apparatus 2000, and does not limit or narrow the scope of possible operations of the pose analyzing apparatus 2000.

The pose analyzing apparatus 2000 is configured to detect, from a target image 10, a reference person whose quality of pose is higher than the quality of pose of a target person. The target person is a person that is specified by a user of the pose analyzing apparatus 2000. The target image 10 is an image data, e.g., an

RGB image or a grayscale image, that includes two or more persons in a visible manner.

The persons captured on the target image 10 does arbitrary thing. For example, the persons give a performance, such as figure skating or dance. In another example, the persons perform exercises, such as yoga. In another example, the persons play music instrument, such as guitar or piano. In another example, the persons attend a class in school. In another example, the persons do a task of work, such as operations of assembling components in a factory, or patrols in a building.

To detect the reference person, the pose analyzing apparatus 2000 may operate as follows. The pose analyzing apparatus 2000 acquires the target image 10 and target person information 20 that indicates the target person. The pose analyzing apparatus 2000 estimates a pose for each person captured on the target image 10, and computes a pose score for each one of the persons. The pose score of a particular person represents how high the quality of the pose of the person is. The pose analyzing apparatus 2000 detects, as the reference person, the person having the pose score greater than the pose score of the target person. The pose analyzing apparatus 2000 outputs reference information 30 that indicates the reference person.

It is noted that the pose analyzing apparatus 2000 may handle two or more target images 10 that are generated in parallel and include different persons from each other. In this case, two or more cameras are installed to capture different areas (e.g., different areas in a lesson room in which the persons are taking a lesson of a performance) from each other, and each of the cameras is configured to generate the target image 10. The pose analyzing apparatus 2000 may analyze each of those target images 10 to detect one or more persons therefrom, and compute the pose score for each one of the detected persons.

For the sake of brevity, unless otherwise stated, it is assumed that there is only a single camera that generates the target image 10. Unless otherwise stated, the pose analyzing apparatus 2000 that handles cases where there are two or more cameras that generate the target images 10 may operate in the same manner as the pose analyzing apparatus 2000 that handles cases where there is only a single camera that generates the target image 10.

### Example of Advantageous Effect

According to the pose analyzing apparatus 2000 of the first example embodiment, the target image on which two or more persons are captured is acquired, the pose of each person is estimated, the pose score of each person is computed, and the reference person whose quality of pose is higher than the target person is detected. Thus, a novel technique of analyzing poses of persons using an image on which two or more persons are captured is provided.

In addition, the pose analyzing apparatus 2000 outputs the reference information 30 that indicates the reference person. Information indicating the reference person is effective and useful in various ways. Briefly, a viewer of the reference information 30 can easily and naturally distinguish the reference person, i.e., the person whose quality of pose is higher than the target person, from the other persons captured on the target image 10.

In some embodiments, the pose analyzing apparatus 2000 may be used in an environment where the persons captured on the target image 10 are trainees of a performance or the like and the user of the pose analyzing apparatus 2000 is one of the trainees. In this case, it is effective and useful for the user to refer to the person whose quality of pose is higher than that of the user to improve the pose of the user. However, in some situations, it may be difficult for the user to realize which one of the trainees takes a better pose than the user.

According to the pose analyzing apparatus 2000, the reference person is automatically detected, and the reference information 30 that indicates the reference person is provided. Thus, it becomes easier for the user to notice the person whose quality of pose is higher than the user. The user therefore can easily refer to the pose of the reference person to improve the pose of the user.

Hereinafter, more detailed explanation of the pose analyzing apparatus 2000 will be described.

### Example of Functional Configuration

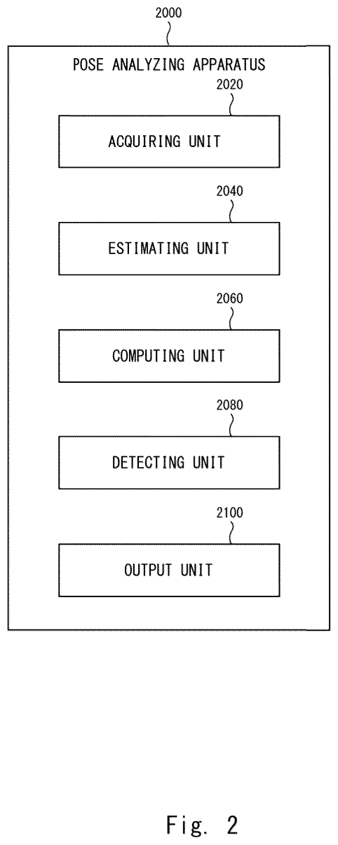

FIG. 2 is a block diagram illustrating an example of the functional configuration of the pose analyzing apparatus 2000 of the first example embodiment. The pose analyzing apparatus 2000 includes an acquiring unit 2020, an estimating unit 2040, a computing unit 2060, a detecting unit 2080, and an output unit 2100. The acquiring unit 2020 acquires the target image 10 and the target person information 20. The estimating unit 2040 estimates the pose of each person captured on the target image 10. The computing unit 2060 computes the pose score for each person. The detecting unit 2080 detects, as the reference person, the person whose pose score is greater than the pose score of the target person. The output unit 2100 outputs the reference information 30.

### Example of Hardware Configuration

The pose analyzing apparatus 2000 may be realized by one or more computers. Each of the one or more computers may be a special-purpose computer manufactured for implementing the pose analyzing apparatus 2000, or may be a general-purpose computer like a personal computer (PC), a server machine, or a mobile device.

The pose analyzing apparatus 2000 may be realized by installing an application in the computer. The application is implemented with a program that causes the computer to function as the pose analyzing apparatus 2000. In other words, the program is an implementation of the functional units of the pose analyzing apparatus 2000 that are exemplified by FIG. 2.

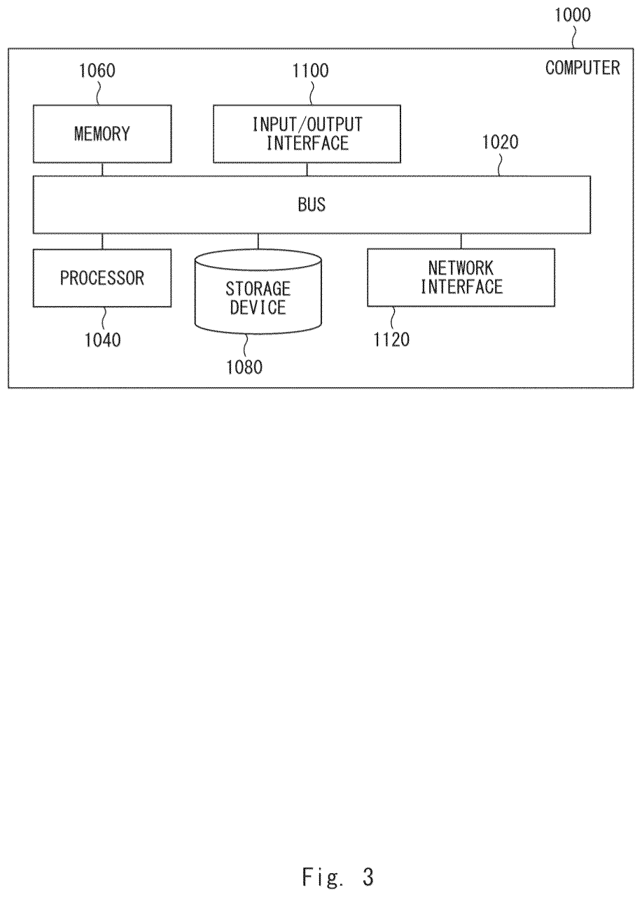

FIG. 3 is a block diagram illustrating an example of the hardware configuration of a computer 1000 realizing the pose analyzing apparatus 2000 of the first example embodiment. In FIG. 3, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), DSP (Digital Signal Processor), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The hardware configuration of the computer 1000 is not restricted to that shown in FIG. 3. For example, as mentioned-above, the pose analyzing apparatus 2000 may be realized as a combination of multiple computers. In this case, those computers may be connected with each other through the network.

### Flow of Process

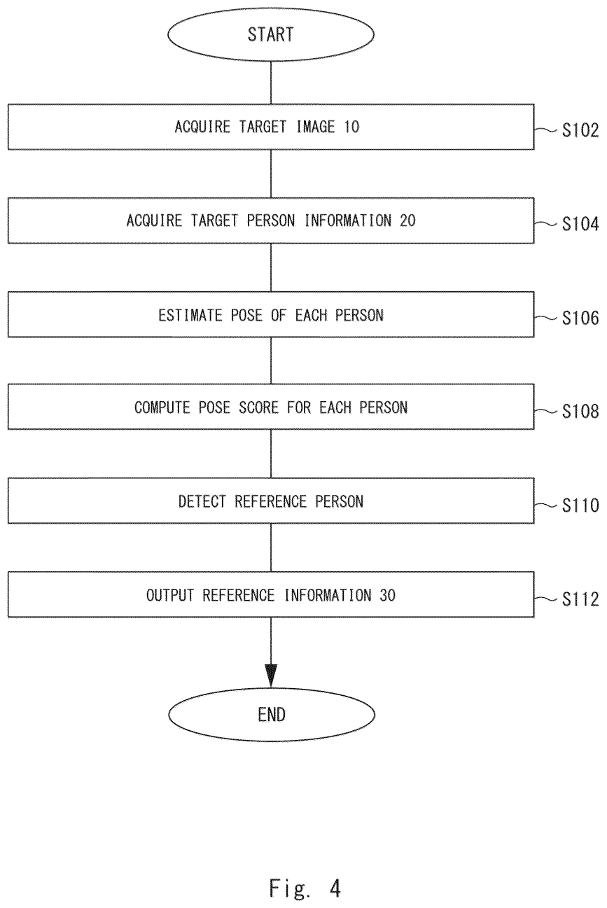

FIG. 4 is a flowchart illustrating an example flow of processes performed by the pose analyzing apparatus 2000 of the first example embodiment. The acquiring unit 2020 acquires the target image 10 (S102). The acquiring unit 2020 acquires the target person information 20 (S104). The estimating unit 2040 estimates the pose for each of the persons captured on the target image 10 (S106). The computing unit 2060 computes the pose score for each person (S108). The detecting unit 2080 detects the reference person based on the pose scores of the persons (S110). The output unit 2100 outputs the reference information (S112).

It is noted that the flow of processes shown by FIG. 4 is merely an example, and there may be various variations in flows of processes performed by the pose analyzing apparatus 2000. For example, the acquisition of the target image 10 (S102) and that of the target person information 20 (S104) can be performed in the order opposite to that shown by FIG. 4 or in parallel with each other.

### Acquisition of Target Image 10: S102

The acquiring unit 2020 acquires the target image 10 (S102). As mentioned above, the target image 10 includes one or more persons. In some embodiments, the target image 10 is a video frame, which is one of time-series images that constitute a video data. Hereinafter, this video data is called “target video”. In this case, the acquiring unit 2020 may acquire one or more video frames constituting the target video, and use the acquired video frames as the target images 10.

It is noted that there is no need to use all video frames of the target video as the target images 10. For example, the acquiring unit 2020 acquires every predefined number of video frames, such as every 10 video frames, from the target video as the target images 10. In another example, the acquiring unit 2020 may divide the target video into two or more sections, and acquire one or more video frames from each section as the target images 10.

In some embodiments, the target video may be divided into sections based on the length of time. Specifically, in this case, the target video is divided into sections each of which has a predefined length of time. In other embodiments, the acquiring unit 2020 may recognize two or more scenes captured on the target video, and divide the target video into sections each of which represents one of the recognized scenes.

Suppose that a performance of figure skating is captured on the target video. In this case, the target video may include scenes of a jump, a spin, steps, etc. Thus, the acquiring unit 2020 divides the target video into sections of the jump, spin, steps, etc.

It is noted that there are various techniques to recognize scenes from a video data, and any one of those techniques can be applied to the acquiring unit 2020 to recognize scenes from the target video.

There are various ways to acquire the target image 10. In some embodiments, the target image 10 is stored in advance in a storage device in a manner that the pose analyzing apparatus 2000 can acquire it. In this case, the acquiring unit 2020 may access the storage device to acquire the target image 10. In other embodiments, the target image 10 may be sent by another computer, such as a camera that generates the target image 10, to the pose analyzing apparatus 2000. In this case, the acquiring unit 2020 may acquire the target image 10 by receiving it. When the target image 10 is sent by the camera, the acquiring unit 2020 may acquire the target image 10 in real time.

In the case where the acquiring unit 2020 acquires the target video, the target video may be acquired in a way similar to the way of acquiring the target image 10. The acquiring unit 2020 may acquire the target video in real time. Specifically, a video camera that generates the target video may repeatedly perform: capturing a surrounding scene to generate a video frame of the target video; and outputting the generated video frame to the pose analyzing apparatus 2000. In this case, the acquiring unit 2020 receives the video frames that are sequentially sent by the video camera, and a time-series of the received video frames forms the target video.

### Acquisition of Target Person Information 20: S104

The acquiring unit 2020 acquires the target person information 20 that indicates the target person (S104). The target person is indicated by the target person information 20 in such a manner that the pose analyzing apparatus 2000 can detect the target person from the target image 10 based on the target person information 20.

For example, the acquiring unit 2020 may acquire the target person information 20 that includes a sample image of the target person on which a part (e.g., a face) or a whole of the target person is captured. In another example, the acquiring unit 2020 may acquire the target person information 20 that includes features that are extracted from the sample image of the target person. In another example, when relative locations of the respective persons captured on the target image 10 are defined in advance, the target person information 20 may indicate the location of the target person. Suppose that the target image 10 includes four persons, and the target person is always captured on a top-left region of the target image. In this case, the target person information 20 indicates “top-left” as the location of the target person.

The target person information 20 mentioned above may be acquired in a way similar to the way of acquiring the target image 10.

In another example, the acquiring unit 2020 may prompt a user of the pose analyzing apparatus 2000 to input the target person information 20. In this case, the acquiring unit 2020 may output the target image 10 and let the user select one of the persons captured on the target image 10. Specifically, the acquiring unit 2020 outputs the target image 10 to a display device so that the display device shows the target image 10. The target image 10 is displayed on the display device in a manner that the user can select any one of the persons captured on the target image 10. When the user selects one of the displayed persons, the acquiring unit 2020 acquires information (e.g., coordinates on the target image 10 that are specified by the user) with which the pose analyzing apparatus 2000 can determine which one of the persons is selected by the user, as the target person information 20.

### Estimation of Poses: S106

The estimating unit 2040 estimates the pose of each person captured on the target image 10 (S106). There are various techniques of pose estimation, and one of those techniques may be applied to the estimating unit 2040. For example, the estimating unit 2040 detects locations of characteristic parts (such as neck, eyes, shoulders, etc.) of human's body as key-points from the target image 10. Then, the estimating unit 2040 divides the key-points into groups, called “key-point groups”, each of which includes the key-points belonging to the same person as each other, thereby estimating the pose of each person based on the key-point group that corresponds to the person.

The pose of the person may be classified into one of predefined types of poses, such as a jump, a spin, or steps of figure skating. In this case, the pose of a particular person is represented by a pair of the key-point group of the person and a label, called “type label”, that indicates a type of pose taken by the person. In order to recognize the type of pose of the person, the estimating unit 2040 may include a classification model that is configured to take a set of the key-points (i.e., the key-point group) of the person and to output the type label that indicates the type of the pose taken by the person. The classification model may be implemented by a machine learning-based model, such as a neural network.

As mentioned later, the computing unit 2060 may use not a single pose of the person but a time-series of poses of the person to compute the pose score of the person. In this case, the estimating unit 2040 uses a time-series of the target images 10 to estimate poses of the persons from each target image 10, thereby obtaining a time-series of poses for each person. It is note that a time-series of poses can also be called “motion”. Thus, when the time-series of poses of the persons are used to compute the pose score, it can be said that the pose analyzing apparatus 2000 computes the pose score that represents how high the quality of the motion of the person is.

### Computation of Pose Score: S108

The computing unit 2060 computes the pose score for each person (S108). Hereinafter, example ways of computing the pose score will be described.

### EXAMPLE 1

In some embodiments, the computing unit 2060 computes the pose score that represents a degree of similarity between the pose of the person and a predefined sample pose. The sample pose may be defined by a set of key-points that represent an ideal pose. In this case, it can be said that the more similar the pose of the person is to the sample pose, the higher the quality of the pose is.

There are various ways to quantify the similarity between two poses, and one of those ways can be applied to the computing unit 2060 to compute the pose score. Briefly, the degree of similarity between the pose of the person and the sample pose may be represented by a degree of similarity between a spatial arrangement of the key-points in the key-point group of the person and a spatial arrangement of the key-points of the sample pose.

In some embodiments, the computing unit 2060 includes a machine learning-based feature extractor, such as a neural network, that is configured to take a key-point group as input and to output features of the pose represented by the key-point group (e.g., features of the spatial arrangement of the key-points in the key-point group). In this case, the computing unit 2060 inputs the key-point group of the person into the feature extractor to obtain the features of the pose of the person. The computing unit 2060 also inputs the key-point group of the sample pose into the feature extractor to obtain the features of the sample pose. Then, the computing unit 2060 computes, as the pose score, a value representing the similarity between the features of the pose of the person and the features of the sample pose. It is noted that there are various ways to quantify similarity between two sets of features, and one of those ways can be applied to the computing unit 2060 to quantify the similarity of the features of the pose of the person and the features of the sample pose.

In order to compute the pose score, the computing unit 2060 may acquire information, called “sample information”, that indicates the sample pose: e.g., a key-point group that represents the sample pose. The sample information may be stored in a storage device in advance in a manner that the pose analyzing apparatus 2000 can obtain the sample information.

It is possible that two or more sample poses are prepared. Hereafter, these sample poses are called “candidate sample pose”. In this case, the computing unit 2060 chooses one of those candidate sample poses as the sample pose to be used to compute the similarity score. For example, the user of the pose analyzing apparatus 2000 specifies the candidate sample pose to be used as the sample pose. In this case, the computing unit 2060 may acquire the candidate sample pose specified by the user as the sample pose to compute the similarity score.

In another example, the computing unit 2060 may choose one of the candidate sample poses based on similarity between the pose of the target person and each candidate sample pose. Specifically, the computing unit 2060 may compute, for each candidate sample pose, a candidate score that represents a degree of similarity between the candidate sample pose and the pose of the target person.

Then, the computing unit 2060 chooses the candidate sample pose with the greatest candidate score as the sample pose to compute the pose score. It is noted that a way of computing the candidate score is the same as the way of computing the pose score based on the sample pose that is mentioned above.

In some embodiments, the computing unit 2060 may use a time-series of poses (motion) of the person to compute the pose score. In this case, a time-series of sample poses, called “sample motion”, may be prepared in advance. The sample motion may be represented by a time-series of key-point groups each of which represent a sample pose at a time. The computing unit 2060 computes, for each person, the pose score that represents a degree of similarity between the motion of the person and the sample motion.

There are various ways to quantify the similarity between two motions, and one of those ways can be applied to the computing unit 2060. Briefly, the degree of similarity between the motion of the person and the sample motion may be represented by a degree of similarity between a time-series of spatial arrangements of the key-points of the person and a time-series of spatial arrangements of the key-points of the sample motion.

In some embodiments, the computing unit 2060 includes a machine learning-based feature extractor, such as a neural network, that is configured to take a time-series of key-point groups as input and to output features of the motion represented by the time-series of the key-point groups. In this case, the computing unit 2060 inputs the time-series of the key-point groups of the person into the feature extractor to obtain the features of the motion of the person. The computing unit 2060 also inputs the time-series of the key-point groups of the sample motion into the feature extractor to obtain the features of the sample motion. Then, the computing unit 2060 computes, as the pose score, a value representing the similarity between the features of the motion of the person and the features of the sample motion.

It is also noted that when two or more candidates of sample motions, called “candidate sample motions” are prepared, the computing unit 2060 may choose one of those candidate sample motions as the sample motion to be used to compute the pose score. This choice may be performed in a way similar to the way to choose the sample pose from the candidate sample poses.

For example, the computing unit 2060 may acquire the sample information that specifies the candidate sample motion, and choose the candidate sample motion that is specified by the sample information as the sample motion to compute the pose score. In another example, the computing unit 2060 may compute the candidate score for each candidate sample motion, and choose the candidate sample motion with the greatest candidate score as the sample motion to compute the pose score. In this case, the candidate score may be computed as a value representing a degree of similarity between the candidate sample motion and the motion of the target person.

### Consideration of Trajectory of Representative Key-point

In addition to the motion of the person, the computing unit 2060 may also use a time-series (in other words, trajectory) of a representative key-point of the person. The representative key-point of the person may be one of the key-points included in the key-point group of the person, such as a right ankle key-point. It is noted that two or more types (e.g., a right ankle key-point and a left waist key-point) of representative key-points can be used to compute the pose score.

When the trajectory of the representative key-point is used to compute the pose score, the computing unit 2060 may compute a degree of similarity between the motion of the person and the sample motion as the first score SI, and compute a degree of similarity between the trajectory of the representative key-point of the person and the trajectory of the representative key-point of the sample motion as the second score S2. Then, the first score SI and the second score S2 are aggregated into the pose score S. For example, a weighted sum of the first score

S1 and the second score S2 may be computed as the pose score S as follows:

$$Equation 1$$

$$S = α * {S}_{1} + β * {S}_{2} \qquad ( 1 )$$

$$s . t . α + β = 1 , 0 \leq α , β ⊆ ℝ < 1$$

It is noted that when two or more types of the representative key-points are defined, a degree of similarity between the trajectory of the representative key-point of the person and the trajectory of the representative key-point of the sample motion is computed for each type of the representative key-point, and they are aggregated into the second score S2. This aggregation may be performed in a way similar to the way of aggregating the first score and the second score into the pose score.

In the case where different types of poses are taken in the target image 10, it is preferable to prepare the sample pose for each type of pose since each type of pose has its own ideal pose. In addition, it is considered that the target person wants to refer to a person who takes a pose of the same type as the target person.

Thus, in this case, the estimating unit 2040 estimates the pose of each person by generating the key-point group of the person and determining the type label of the person. Then, the computing unit 2060 determines the persons whose type labels are same as the target person, and computes the pose score for each one of the determined persons based on the sample pose corresponding to the type label of the target person. It is noted that the sample pose is prepared in advance in association with the type label.

It is also noted that since the pose score is computed only for the persons whose type labels are the same as the target person, the detecting unit 2080 detects the reference person from the persons for whom the pose score is computed (i.e., the persons whose type label are the same as the target person).

### EXAMPLE 2

In some embodiments, the computing unit 2060 may divide the persons captured on the target image 10 into two or more clusters based on similarity among their poses to compute the pose score. This means that the persons taking similar poses to each other are assigned to the cluster same as each other, while the persons taking dissimilar poses from each other are assigned to the cluster different from each other. In other words, each cluster represents a group of the persons that take similar poses to each other.

The computing unit 2060 compute the pose score of each person based on the size of the cluster to which the person belongs. When it is known in advance that a majority of the persons take poses of high quality, a cluster of the persons whose poses have higher quality may include more persons than a cluster of the persons whose poses have lower quality. Thus, the computing unit 2060 may assign a greater pose score to a person as the number of the persons in the cluster to which that person belongs is greater. Specifically, the computing unit 2060 may compute, as the pose score of a particular person, the percentage of the persons included in the cluster to which that person belongs.

On the other hand, when it is known in advance that a majority of the persons take poses of low quality, a cluster of the persons whose poses have lower quality may include more persons than a cluster of the persons whose poses have higher quality. Thus, the computing unit 2060 may assign a greater pose score to a person as the number of the persons in the cluster to which that person belongs is smaller. Specifically, the computing unit 2060 may compute, as the pose score of a particular person, a reciprocal of the percentage of the persons included in the cluster to which that person belongs.

To divide the persons into clusters, the computing unit 2060 may perform clustering, such as k-means clustering, on the key-point groups of the persons. It is noted that the key-point group can be represented by a multi-dimensional data (e.g., an array of locations of body parts), and there are various ways to perform clustering on a set of multi-dimensional data. Thus, one of those ways can be applied to the computing unit 2060 to perform clustering on a set of the key-point groups. It is also noted that the number of the clusters may be defined in advance or may be determined dynamically as a result of the clustering.

### Detection of Reference Person: S108

The detecting unit 2080 detects the reference person from the target image 10 (S108). First, the detecting unit 2080 determines which one of the persons is the target person based on the target person information 20. There are various ways to detect a specific person from an image based on one or more pieces of information (e.g., features) of the person, and one of those techniques can be applied to the detecting unit 2080 to detect the target person from the target image 10. It is noted that when the computing unit 2060 has already detected the target person from the target image 10, there is no need for the detecting unit 2080 to detect the target person from the target image 10.

The detecting unit 2080 determines whether there are one or more persons whose pose scores are greater than the pose score of the target person. When there is no person whose pose score is greater than the pose score of the target person, the detecting unit 2080 determines that no reference person is detected from the target image 10. On the other hand, when there are one or more persons whose pose scores are greater than the pose score of the target person, the detecting unit 2080 may determine one or more of those persons as the reference persons.

In some embodiments, the number of the reference persons may be defined in advance. When the number of the reference person is defined as one, the detecting unit 2080 may determine the person with the greatest pose score as the reference person. When the number of the reference person is defined as N (N>1), the detecting unit 2080 may determine, as the reference persons, the first person to the n-th person in descending order of the pose score.

In other embodiments, the number of the reference persons may not be defined in advance. For example, the detecting unit 2080 may divide the persons captured on the target image 10 into two or more groups, called “pose groups”, based on the pose score, and determine one or more of the pose groups as groups of the reference persons. Hereinafter, a group of the reference persons is called “reference group”. The reference group is a pose group that includes the persons whose pose scores are greater than the pose score of the target person.

The pose groups may be associated with different ranges of the pose score, called “score range”, from each other. The score ranges are defined not to overlap each other. Suppose that a whole range of the pose score S is 0<=S<=100, and three pose groups GP1, GP2, and GP3 are defined. In this case, the pose groups GP1, GP2, and GP3 can be defined as follows: the pose group GPI has the score range of 0<=S<33; the pose group GP2 has the score range of 33<=S<66; and the pose group GP3 has the score range of 66<=S<=100.

The detecting unit 2080 determines, for each person, one of the score ranges that includes the pose score of the person, and assign the person to the pose group that corresponds to the determined score range. Suppose that there are three pose groups GP1, GP2, and GP3 mentioned above. In addition, there are six persons PI with the pose score of 20, P2 with the pose score of 70, P3 with the pose score of 60, P4 with the pose score of 45, P5 with the pose score of 10, and P5 with the pose score of 80. In this case, the persons PI and PS are assigned to the pose group GP1, the persons P3 and P4 are assigned to the pose group GP2, and the persons P2 and P6 are assigned to the pose group GP3.

The detecting unit 2080 determines the pose groups whose pose scores are greater than those of the pose group to which the target person belongs. Suppose that the target person is the person P3 in the above example. In this case, the pose group to which the target person belongs is the pose group GP2. Thus, the detecting unit 2080 determines the pose group GP3 as the reference group since the pose scores of the pose group GP3 (i.e., 66<=S<100) are greater than the pose scores of the pose group GP2 (i.e., 33<=S<66).

When there are two or more pose groups whose pose scores are greater than those of the pose group to which the target person belongs, the detecting unit 2080 may determine all or a part of those pose groups as the reference pose groups. For example, the detecting unit 2080 may determine the pose group whose pose scores are greatest of all as the reference group.

When the persons are divided into clusters by the computing unit 2060 to compute the pose score, the detecting unit 2080 can handle each cluster as the pose group. In this case, the detecting unit 2080 may compute, for each pose group, a statistic value (e.g., average value) of the pose scores of the persons in the pose group. Then, as the reference groups, the detecting unit 2080 may determine one or more pose groups whose statistic value of the pose scores is greater than the pose score of the target person. In another example, as the reference groups, the detecting unit 2080 may determines one or more pose groups whose statistic value of the pose scores is greater than the statistic value of the pose scores of the pose group to which the target person belongs.

### Output of Reference Information 20: S110

The output unit 2100 outputs the reference information 30 (S110). The reference information 30 includes one or more pieces of information related to one or more reference persons. In some embodiments, the output unit 2100 modifies the target image 10 so that a viewer of the modified target image 10 can notice one or more reference persons, and the modified target image 10 (hereinafter, called “output image”) is included in the reference information 30.

For example, the output image includes a mark, such as a bounding box, on or around the reference person. When two or more reference persons are detected, the output image may be generated by modifying the target image 10 to add common marks, such as bounding boxes with the same color as each other, on or around the reference persons. It is preferable that the output image also indicates the target person in a manner where the target person can be distinguished from the reference persons.

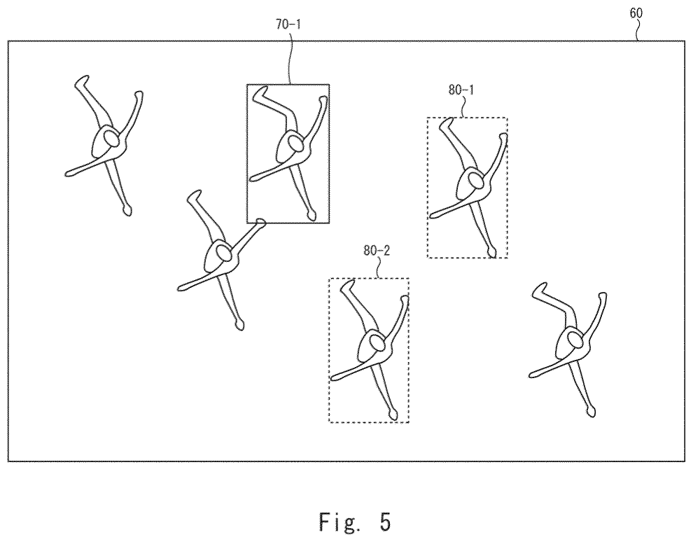

FIG. 5 illustrates an example of the output image. The output image 60 includes a mark 70 to show the target person, and marks 80-1 and 80-2 to show the reference persons. The mark 70 is the bounding box with solid line whereas the marks 80 are the bounding boxes with dotted lines. Since their types of line are different from each other, a viewer of the output image 60 can easily and naturally distinguish the target person from the reference persons.

When two or more reference groups are detected, the output image may include the common marks for each reference group. This means that the reference persons belonging to the same reference group are associated with the marks of the same type as each other (e.g., bounding boxes with the same color as each other or those with the same type of line as each other). On the other hand, the reference persons belonging to different reference groups from each other are associated with the marks of the different types from each other (e.g., bounding boxes with the different colors from each other or those with the different types of lines from each other).

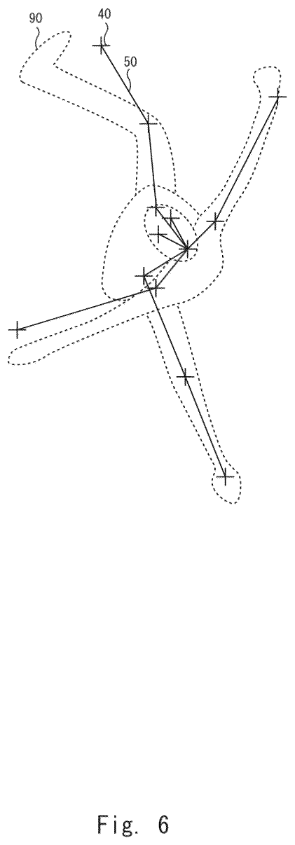

The output unit 2100 may generate the output image in which the pose of the reference person is superimposed on the target person. FIG. 6 illustrates an image of the target person on which the pose of the reference person is superimposed. In FIG. 6, the pose of the reference person is illustrated by the key-points 40 and links 50, and superimposed on an image 90 the target person. The link 50 represents a connection between adjacent key-points, such as the neck and the right shoulder, the left waist and the left knee, etc.

When superimposing the pose of the reference person on the target person, the output unit 2100 may adjust the pose of the reference person to fit the target person. For example, the output unit 2100 may adjust the size of the reference person to the size of the target person. In another example, the output unit 2100 may adjust the orientation of the reference person to that of the target person.

The reference information 30 may also include information that indicates one or more features of the target person, the reference person, or both: e.g., the similarity score of the person, accuracy of pose estimation for the person, or good or bad points of the person. Those pieces of information may be included in or outside the output image.

The accuracy of pose estimation for a particular person represents how accurately the pose of the person is estimated by the estimating unit 2040. In this case, the estimating unit 2040 is configured to compute the accuracy of pose estimation for each person while estimating the pose of the person.

To compute the accuracy of pose estimation, the estimating unit 2040 may be configured to include a machine learning-based pose estimator, such as a neural network, that can compute the accuracy of pose estimation. Specifically, the pose estimator may be configured to take an image region on which a particular person is captured, and to output, for each predefined part of human's body, the key-point of the part and accuracy of that key-point. The accuracy of pose estimation for a particular person may be represented by a list of the accuracies of the key-points of the person, or may be represented by a statistic value (e.g., average value) of the accuracies of the key-points of the person.

As mentioned above, other examples of the features of the person that may be included in the reference information 30 are good points, bad points, or both of the person. When those pieces of information are included in the reference information 30, the computing unit 2060 may additionally compute a score (called “point score”) for each key-point that indicates a degree of similarity between the key-point of the target person and the key-point of the sample pose.

For example, the output unit 2100 may determine, as good key-points, one or more key-points of the target person whose point scores are greater than a predefined threshold Th1. Then, the output unit 2100 generates the reference information 30 that indicates the good key-points of the target person.

Similarly, the output unit 2100 may determine, as bad key-points, one or more key-points of the target person whose point scores are less than a predefined threshold Th2 (Th2<Th1). Then, the output unit 2100 generates the reference information 30 that indicates the bad key-points of the target person.

The pose analyzing apparatus 2000 may store history information that includes history of bad key-points for each person. In this case, the output unit 2100 may determine whether the bad key-point of the target person that is currently detected is included in the history information to determine the contents of the reference information 30. When the currently-detected bad key-point is included in the history information, it can be said that the user should pay careful attention to the part corresponding to this bad key-point to improve her or his pose. Thus, the output unit 2100 may generate the reference information 30 that emphasizes the bad key-point that is included in the history information more than the bad key-point that is not included in the history information.

In addition to pointing out the bad key-points, the reference information 30 may also include how the pose of the target person can be improved. Suppose that the right knee key-point of the target person is determined as the bad key-point due to its position is lower than the ideal one (i.e., the position of the right knee key-point of the sample pose). In this case, the pose of the target person can be improved by getting the right knee up more. Thus, the output unit 2100 generates the reference information 30 that includes a message indicating that the target person should get the right knee up more.

In addition to or instead of the pose scores of individual persons, the reference information 30 may include a statistic value regarding the pose score. An example of the statistic value regarding the pose score is the number of the persons whose pose scores are greater than the pose score of the target person: in other words, the number of persons whose quality of pose are higher than the quality of the pose of the target person.

When the reference group is generated, the reference information 30 may include one or more statistic values regarding the pose score for each reference group: e.g., an average, variance, maximum, or minimum of the pose scores of the reference persons in the reference group.

In some embodiments, the pose analyzing apparatus 2000 acquires the target images 10 constituting the target video and output the reference information 30 in real time. In this case, the viewer can easily notice the reference person in real time.

Suppose that one or more cameras are installed in a lesson room where multiple trainees take a lesson of a performance, generate the target images 10 constituting the target video, and send them to the pose analyzing apparatus 2000. In addition, the pose analyzing apparatus 2000 receives the target image 10, detects the reference person, and outputs a sequence of the output images, called “output video”, to a display device in real time.

In this case, the user (e.g., one of the trainees) of the pose analyzing apparatus 2000 can easily refer to the performance of another trainee whose quality is higher than the performance of the user. This may enable the user to compare her or his performance with that of the reference person, and to realize the difference therebetween and what the user should improve in her or his performance.

It is noted that there are various ways for the output unit 2100 to output the reference information 30. In some implementations, the reference information 30 may be put into a storage device, displayed on a display device, or sent to another computer such as a PC or smart phone of the user of the pose analyzing apparatus 2000.

### EXAMPLE EMBODIMENT 2

### Overview

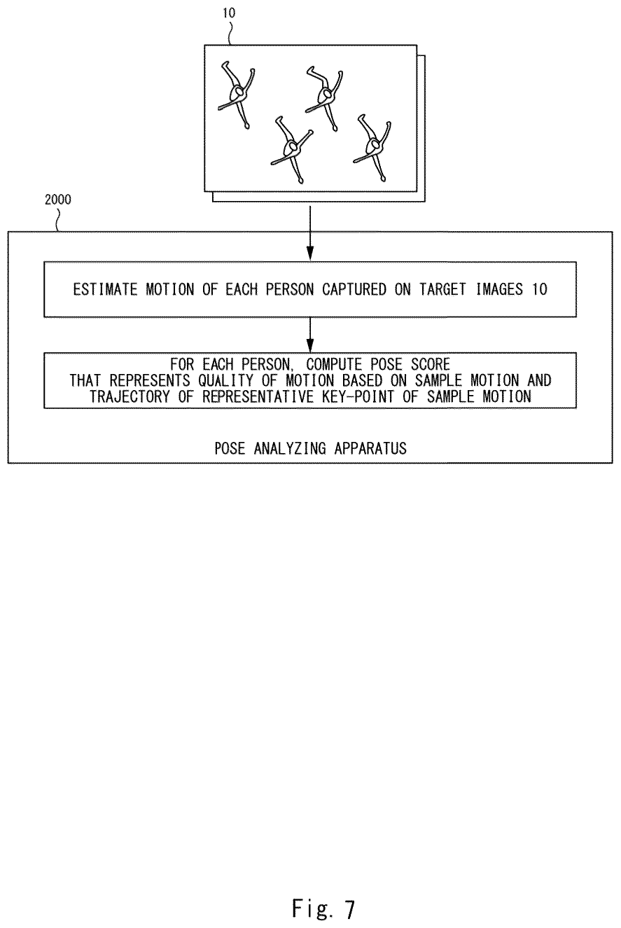

FIG. 7 illustrates an overview of a pose analyzing apparatus 2000 of the second example embodiment. It is noted that the overview illustrated by FIG. 7 shows an example of operations of the pose analyzing apparatus 2000 of the second example embodiment to make it easy to understand the pose analyzing apparatus 2000 of the second example embodiment, and does not limit or narrow the scope of possible operations of the pose analyzing apparatus 2000 of the second example embodiment.

The pose analyzing apparatus 2000 of the second example embodiment is configured to compute the pose score based on the sample motion and the trajectory of the representative key-point of the sample motion. It is noted that, as mentioned in the first example embodiment, two or more types of representative key-points can be used to compute the pose score.

For example, as exemplified in the first example embodiment, the pose analyzing apparatus 2000 of the second example embodiment may compute a degree of similarity between the motion of the person and the sample motion as the first score S1, and compute a degree of similarity between the trajectory of the representative key-point of the person and the trajectory of the representative key-point of the sample motion as the second score S2. Then, the first score S1 and the second score S2 are aggregated into the pose score S.

It is not required for the pose analyzing apparatus 2000 of the second example embodiment to acquire the target person information 20 and to detect the reference person from the persons captured on the target image 10.

The pose analyzing apparatus 2000 may use the pose score to generate and output information called “output information”. For example, the output unit 2100 of the second example embodiment divides the persons into the pose groups based on their pose scores, and generate the output information that indicates one or more pose groups. To indicate the pose groups, the output information may include the output video that is generated by modifying the target images 10 to show the pose groups. Specifically, the output image may have common marks on the persons who belong to the same pose group as each other.

In another example, the output information may include one or more statistic values that are computed based on the pose scores. For example, the statistic values may include the average, variance, maximum, minimum, etc. of the pose scores. These statistic values may be computed for each pose groups or for all of the persons captured on the target image 10. In another example, the statistic values may include the number or percentage of the persons for each pose group.

### Example of Advantageous Effect

According to the pose analyzing apparatus 2000 of the second example embodiment, the time-series of the target images on which two or more persons are captured is acquired, and the pose of each person is estimated. Then, the pose score of each person is computed based on the sample motion and the trajectory of the representative key-point of the sample motion. Thus, a novel technique of analyzing poses of persons using an image on which two or more persons are captured is provided.

In addition, since the pose score is computed not only by comparing the sample motion and the motion of the person but also by comparing the trajectory of the representative key-point of the sample motion and that of the person, the pose analyzing apparatus 2000 of the second example embodiment can evaluate the motion of the person more accurately than a case where the motion of the person is evaluated only by comparing the sample motion and the motion of the person.

Hereinafter, more detailed explanation of the pose analyzing apparatus 2000 will be described.

### Example of Functional Configuration

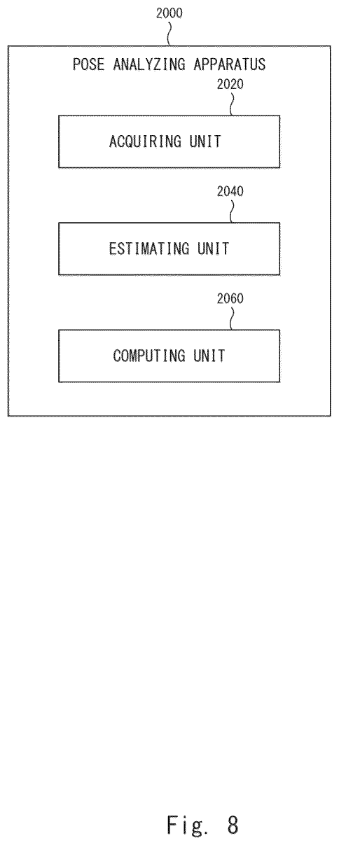

FIG. 8 is a block diagram illustrating an example of the functional configuration of the pose analyzing apparatus 2000 of the second example embodiment. The pose analyzing apparatus 2000 includes the acquiring unit 2020, the estimating unit 2040, and the computing unit 2060. The acquiring unit 2020 acquires a time-series of the target images 10. The acquiring unit 2020 of the second example embodiment is not required to acquire the target person information 20. The estimating unit 2040 estimates the motion of each person captured on the target images 10. The computing unit 2060 computes the pose score for each person based on the sample motion and the trajectory of the representative key-point of the sample motion.

Although it is not depicted in FIG. 8, the pose analyzing apparatus 2000 of the second example embodiment may further include the output unit 2100 that generates and output the output information mentioned above.

### Example of Hardware Configuration

The pose analyzing apparatus 2000 of the second example embodiment may be implemented in a similar manner to the manner by which the pose analyzing apparatus 2000 of the first example embodiment is realized. For example, the pose analyzing apparatus 2000 of the second example embodiment is realized by the computer 1000 that is illustrated by FIG. 3. However, the storage device 1080 of the second example embodiment includes the program that implements the functions of the pose analyzing apparatus 2000 of the second example embodiment.

### Flow of Process

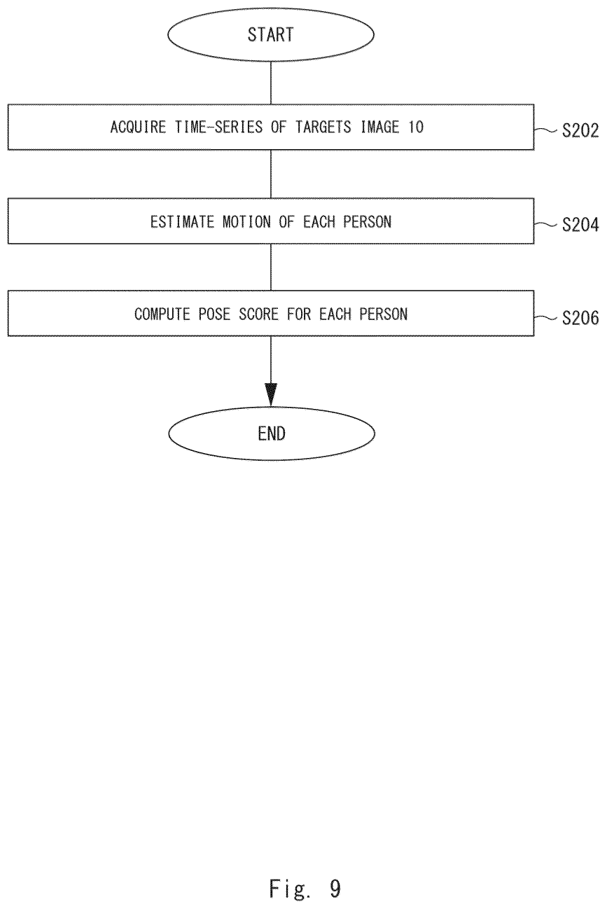

FIG. 9 is a flowchart illustrating an example flow of processes performed by the pose analyzing apparatus 2000 of the second example embodiment. The acquiring unit 2020 acquires the time-series of the target image 10 (S202). The estimating unit 2040 estimates the motion for each of the persons captured on the target images 10 (S204). The computing unit 2060 computes the pose score for each person based on the sample motion and the trajectory of the representative key-point of the sample motion (S206).

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

### REFERENCE SIGNS LIST

10 target image
20 target person information
30 reference information
40 key-point
50 link
60 output image
70 mark
80 mark
90 image
1000 computer
1020 bus
1040 processor
1060 memory
1080 storage device
1100 input/output interface
1120 network interface
2000 pose analyzing apparatus
2020 acquiring unit
2040 estimating unit
2060 computing unit
2080 detecting unit
2100 output unit

What is claimed is:

1. A pose analyzing apparatus comprising:
at least one memory that is configured to store instructions; and
at least one processor that is configured to execute the instructions to:
acquire a target image on which two or more persons are captured;
acquire target person information that indicates a target person;
estimate a pose for each one of the persons captured on the target image;
compute, for each one of the persons, a pose score that represents quality of pose of the person;
detect one or more reference persons whose quality of pose is higher than quality of pose of the target person; and
output reference information that indicates the reference person.

2. The pose analyzing apparatus according to claim 1,
wherein the computation of the pose score includes:
acquiring a sample pose; and
for each one of the persons, computing a degree of similarity between the pose of the person and the sample pose to compute the pose score.

3. The pose analyzing apparatus according to claim 2,
wherein the computation of the pose score includes:
for each one of the persons, computing a first score and a second score and aggregating the first score and the second score into the pose score, the first score representing a degree of similarity between the pose of the person and the sample pose, the second score representing a degree of similarity between a trajectory of a representative key-point of the person and a trajectory of a representative key-point of the sample pose.

4. The pose analyzing apparatus according to claim 2,
wherein the acquisition of the sample pose includes:
for each one of candidate sample poses, computing a candidate score that represents a degree of similarity between the candidate sample pose and the pose of the target person; and
choosing the candidate sample pose with the greatest candidate score as the sample pose.

5. The pose analyzing apparatus according to claim 1,
wherein the computation of the pose score includes:
performing clustering on the persons based on the poses of the persons to divide the persons into two or more clusters; and
for each person, computing the pose score based on a size of the cluster to which the person belongs.

6. The pose analyzing apparatus according to claim 1,
wherein the reference information includes an output image that is generated by modifying the target image to show a mark that indicates the reference person.

7. The pose analyzing apparatus according to claim 6,
wherein the pose of the reference person is superimposed on the target person in the output image.

8. A pose analyzing method performed by a computer, comprising:
acquiring a target image on which two or more persons are captured;
acquiring target person information that indicates a target person;
estimating a pose for each one of the persons captured on the target image;
computing, for each one of the persons, a pose score that represents quality of pose of the person;
detecting one or more reference persons whose quality of pose is higher than quality of pose of the target person; and
outputting reference information that indicates the reference person.

9. The pose analyzing method according to claim 8,
wherein the computation of the pose score includes:
acquiring a sample pose; and
for each one of the persons, computing a degree of similarity between the pose of the person and the sample pose to compute the pose score.

10. The pose analyzing method according to claim 9,
wherein the computation of the pose score includes:
for each one of the persons, computing a first score and a second score and aggregating the first score and the second score into the pose score, the first score representing a degree of similarity between the pose of the person and the sample pose, the second score representing a degree of similarity between a trajectory of a representative key-point of the person and a trajectory of a representative key-point of the sample pose.

11. The pose analyzing method according to claim 9,
wherein the acquisition of the sample pose includes:
for each one of candidate sample poses, computing a candidate score that represents a degree of similarity between the candidate sample pose and the pose of the target person; and
choosing the candidate sample pose with the greatest candidate score as the sample pose.

12. The pose analyzing method according to claim 8,
wherein the computation of the pose score includes:
performing clustering on the persons based on the poses of the persons to divide the persons into two or more clusters; and
for each person, computing the pose score based on a size of the cluster to which the person belongs.

13. The pose analyzing method according to claim 8,
wherein the reference information includes an output image that is generated by modifying the target image to show a mark that indicates the reference person.

14. The pose analyzing method according to claim 13,
wherein the pose of the reference person is superimposed on the target person in the output image.

15. A non-transitory computer-readable storage medium storing a program that causes a computer to execute:
acquiring a target image on which two or more persons are captured;
acquiring target person information that indicates a target person;
estimating a pose for each one of the persons captured on the target image;
computing, for each one of the persons, a pose score that represents quality of pose of the person;
detecting one or more reference persons whose quality of pose is higher than quality of pose of the target person; and
outputting reference information that indicates the reference person.

16. The storage medium according to claim 15,
wherein the computation of the pose score includes:
acquiring a sample pose; and
for each one of the persons, computing a degree of similarity between the pose of the person and the sample pose to compute the pose score.

17. The storage medium according to claim 16,
wherein the computation of the pose score includes:
for each one of the persons, computing a first score and a second score and aggregating the first score and the second score into the pose score, the first score representing a degree of similarity between the pose of the person and the sample pose, the second score representing a degree of similarity between a trajectory of a representative key-point of the person and a trajectory of a representative key-point of the sample pose.

18. The storage medium according to claim 16,
wherein the acquisition of the sample pose includes:
for each one of candidate sample poses, computing a candidate score that represents a degree of similarity between the candidate sample pose and the pose of the target person; and
choosing the candidate sample pose with the greatest candidate score as the sample pose.

19. The storage medium according to claim 15,
wherein the computation of the pose score includes:
performing clustering on the persons based on the poses of the persons to divide the persons into two or more clusters; and
for each person, computing the pose score based on a size of the cluster to which the person belongs.

20. The storage medium according to claim 15,
wherein the reference information includes an output image that is generated by modifying the target image to show a mark that indicates the reference person.

21. (canceled)
